(19) United States
(12) Patent Application Publication
(10) Pub. No.: US 2022/0281370 A1
(43) Pub. Date: Sep. 8, 2022

(54) Multi-Purpose Cup Holder Tray Insert

(71) Applicant: Scott Stubbings, Imperial Beach, CA (US)

(72) Inventor: Scott Stubbings, Imperial Beach, CA (US)

(21) Appl. No.: 17/670,860

(22) Filed: Feb. 14, 2022

Related U.S. Application Data
(60) Provisional application No. 63/158,022, filed on Mar. 8, 2021.

(51) Int. Cl. B60N 3/00; B60N 3/10

(52) U.S. Cl. CPC B60N 3/002; B60N 3/103

(57) ABSTRACT

The present invention relates to a multipurpose cup holder tray insert. The tray insert is designed for placement in a vehicle cup holder to provide a convenient location to place a meal and a beverage container while driving. The tray insert includes: a planar tray portion for food items; a detachably attached pocket for snacks, edibles, or condiments; and, a beverage sleeve for holding a beverage container. The beverage sleeve further includes a circular adapter that is configured to expand and also having a swivel mechanism to rotate the tray portion. The sleeve is telescopic and can be adjusted to different lengths for height adjustments. A square key can be used for expanding the circular adapter for a snug fit in the cup holder.

### CROSS-REFERENCE TO RELATED APPLICATION

The present application claims priority to, and the benefit of, U.S. Provisional Application No. 63/158,022, which was filed on Mar. 8, 2021 and is incorporated herein by reference in its entirety.

### FIELD OF THE INVENTION

The present invention relates generally to the field of tray and/or cup holder devices. More specifically, the present invention relates to a combo meal cup holder, that is a tray designed to be placed in a vehicle cup holder portion, in order to be easily accessed by the driver and other individuals sitting in the car. The combo meal cup holder comprises a locking base that snugly fits into the vehicle cup holder. The base can include a square tool or a key-based locking mechanism for locking the base into the cup holder portion of the vehicle. Additionally, the combo meal cup holder comprises a plate portion having a sleeve for holding drinks and a pocket for holding additional snacks such as french fries. The combo meal cup holder makes the snacks easily accessible to the drivers and prevents them from creating a mess inside their vehicles while eating. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, while travelling to places, the drivers and other individuals in a vehicle can purchase food such as hamburgers, french fries, sandwiches and more, at a drive-through restaurant or pack it from home to enjoy on their route. Individuals hold food items in their hands to eat, place on their lap or place on the passenger seat while eating. However, it is not possible for the drivers to safely drive their vehicles while accessing the food items placed on nearby seats. Eating and drinking while driving is not illegal, however it can still be dangerous. While driving the vehicle, the driver can be easily distracted when trying to access the food or drink, and distracted driving is illegal in most states.

In many situations, food in to-go bags is placed onto the passenger seat, which forces drivers to take their eyes off of the road as they search through the bag for what they need. The food then often ends up on the driver's lap or balanced precariously on the console. This not only makes the food difficult to access, but also creates a mess.

Additionally, in standard vehicles such as cars, a bracket or holder for holding beverages is provided between the arms of the front seats. However, individuals can only place beverages in those brackets, and cannot place food items/snacks in the provided brackets. The food items/snacks are usually held in the hands, or pinned between the legs of the driver, and are eaten while travelling to a destination.

Therefore, there exists a long felt need in the art for a holding and retaining device that allows the users to easily keep their food items such as hamburgers, french fries, sandwiches, etc. secured along with the beverages such as tea, coffee, soft drinks, etc. There is also a long felt need in the art for a holding device that can be used with standard vehicles for setting up the device to hold the food items and beverages while travelling in the vehicle. Additionally, there is a long felt need in the art for a holder that makes the food items and beverages easily accessible to the drivers and to the individuals sitting in the vehicle as well. Moreover, there is a long felt need in the art for a meal holder device that eliminates the need to place the food items and beverages on vacant seats or to hold the same in their hands throughout the journey. Further, there is a long felt need in the art for a device that prevents the driver from taking his or her eyes off of the road while accessing the food items and beverages, and ensures a safe ride to the destination. Furthermore, there is a long felt need in the art for a holding device that securely holds the food items and beverages, and ensures the food items/beverages do not fall and create a mess in the vehicle. Finally, there is a long felt need in the art for a meal-holding device that enables the drivers to pay more attention to the road while eating and driving at the same time.

The subject matter disclosed and claimed herein, in one embodiment thereof, comprises a multipurpose cup holder and tray insert device. The insert device is configured for placement in a vehicle cup holder for providing a convenient location for placing a meal and a beverage. More specifically, the insert device includes: a beverage sleeve configured to receive a beverage container; a planar tray portion; the tray portion extends horizontally including a larger circular portion and a smaller circular portion; a pocket detachably attached to the larger circular portion; and, the beverage sleeve is disposed in the small circular portion. The beverage sleeve includes walls extending down from the tray portion, and an expandable circular adaptor is placed at the bottom of the beverage sleeve. The circular adaptor can be expanded using a square key in order to snugly fit within a cup holder. Further, the tray can be rotated 360 degrees using a swivel mechanism of the circular adaptor.

In this manner, the novel combo meal cup holder of the present invention accomplishes all of the forgoing objectives, and provides a relatively secure, easy and convenient solution to hold food items such as hamburgers, french fries, sandwiches and more, along with the beverages such as tea, coffee, water, soft drinks, etc. The combo meal cup holder of the present invention provides a place to keep multiple items and makes the food items/beverages easily accessible to the vehicle driver and other individuals in the vehicle. Additionally, the combo meal cup holder enables the drivers to pay more attention to the road while eating and driving, therefore ensuring a safer ride to the destination.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tray and beverage holder insert. The tray and beverage holder insert can be configured for placement in a vehicle cup holder to provide a convenient location for placing a meal and a beverage container while driving. The insert further comprises: a beverage sleeve configured to removably receive a beverage container; a planar tray portion integrally formed with the beverage sleeve; the tray portion extends horizontally and includes a larger circular portion and a smaller circular portion; a pocket detachably attached to the larger circular portion and the beverage sleeve disposed in the small circular portion; the beverage sleeve having walls extending down from the tray portion; an expandable circular adaptor at the bottom of the beverage sleeve; and, the circular adaptor is configured to expand using a square key that releases a spring allowing the walls of the circular adaptor to expand. Further, the tray can rotate 360 degrees using a swivel mechanism of the circular adaptor.

In yet a further embodiment of the present invention, a swivel mechanism of the circular adaptor can rotate the beverage sleeve to which the planar tray portion is integrally formed, thereby enabling the tray portion to rotate and position in a desired orientation such as towards a driver's seat or towards a passenger's seat.

In yet a further embodiment of the present invention, a cup holder tray and beverage holder device is disclosed. The device includes: a planar tray made of an anti-skid material or having an anti-skid coating; a telescopic beverage sleeve configured to removably receive a beverage container; the beverage sleeve can be extended or retracted using a plurality of telescopic slots; a circular adaptor configured to rotate the beverage sleeve; and, the integrally formed tray and the circular adaptor are configured to expand to snugly fit cup holders of different sizes.

In yet a further embodiment of the present invention, a cup holder rotatable tray insert device is disclosed. The tray insert comprises: a planar tray; the tray having a vertical lip circumscribing the tray; a beverage cylinder for removably receiving a beverage container; a circular cylinder to closely fit within a cup holder; and the circular cylinder is placed at the floor of the beverage cylinder and is also configured to rotate the beverage cylinder and the integrally formed planar tray using an built-in swivel mechanism.

In yet another embodiment of the present invention, a tray and beverage insert device for a cup holder is disclosed. The insert device closely fits within a cup holder and uses a circular cylinder for a snug fit. The circular cylinder is coupled to a torsional spring, wherein the spring is released using a square key when the square key is inserted in a hole coupled to the circular cylinder and is rotated in a predefined direction. The spring, when released, causes the cylinder to expand to snugly fit within the cup holder.

Advantageously, the insert device of the present invention provides drivers a secure location to place their food and drink while they drive, and enables them to pay more attention to the road while eating and driving. Food items, snacks and drinks can be conveniently and securely placed onto the tray and can be accessed without the drivers taking their eyes off of the road. The tray portion is rotatable and can be rotated left or right for use by the driver or a passenger.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of multipurpose cupholder tray insert of the present invention in accordance with the disclosed architecture;

FIG. 2 illustrates an enlarged perspective view showing the beverage sleeve of the multipurpose cupholder tray insert of the present invention in accordance with the disclosed architecture;

FIG. 3 illustrates a perspective view showing the multipurpose cupholder tray insert of the present invention designed to be inserted in a cup holder of a vehicle in accordance with the disclosed architecture;

FIG. 4A illustrates a perspective view showing the pre-expansion of the circular adaptor of the tray insert of the present invention using a square key in accordance with the disclosed architecture;

FIG. 4B illustrates a perspective view showing the post-expansion of the circular adaptor of the tray insert of the present invention using a square key in accordance with the disclosed architecture;

FIG. 5 illustrates a top perspective view showing the multipurpose cupholder tray insert of the present invention positioned in a cup holder in accordance with the disclosed architecture;

FIG. 6 illustrates a perspective view showing the tray portion rotated towards a driver's seat in accordance with the disclosed architecture;

FIG. 7 illustrates a perspective view showing the tray portion rotated towards a passenger's seat in accordance with the disclosed architecture; and

FIG. 8 illustrates a perspective view showing another embodiment of the multipurpose cupholder tray insert of the present invention with detachable pocket in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a holding and retaining device that allows the users to easily keep their food items secured such as hamburgers, french fries, sandwiches, etc. along with beverages such as tea, coffee, soft drinks, etc. There is also a long felt need in the art for a holding device that can be used with standard vehicles for setting up the device to hold the food items and beverages while travelling in the vehicle. Additionally, there is a long felt need in the art for a holder that makes the food items and beverages easily accessible to the drivers and to the other individuals sitting in the vehicle as well. Moreover, there is a long felt need in the art for a meal holder device that eliminates the need to place the food items and beverages on vacant seats or to hold same in hands throughout the journey. Further, there is a long felt need in the art for a device that prevents the driver from taking his or her eyes off of the road while accessing the food items and beverages, and ensures a safer ride to the destination. Furthermore, there is a long felt need in the art for a holding device that securely holds the food items and beverages, and ensures the food items/beverages do not fall and create a mess in the vehicle. Finally, there is a long felt need in the art for a meal holding device that enables the drivers to pay more attention to the road while eating and driving at the same time.

The present invention, in one exemplary embodiment, includes a novel cup holder tray and beverage holder device. The device includes: a planar tray having an anti-skid coating for preventing slipping of food items; a telescopic beverage sleeve configured to removably receive a beverage container; a circular adaptor configured to rotate the beverage sleeve and the integrally formed tray; and, the circular adaptor is configured to expand to snugly fit cup holders of different sizes. The device prevents drivers from creating a mess inside their vehicles while eating.

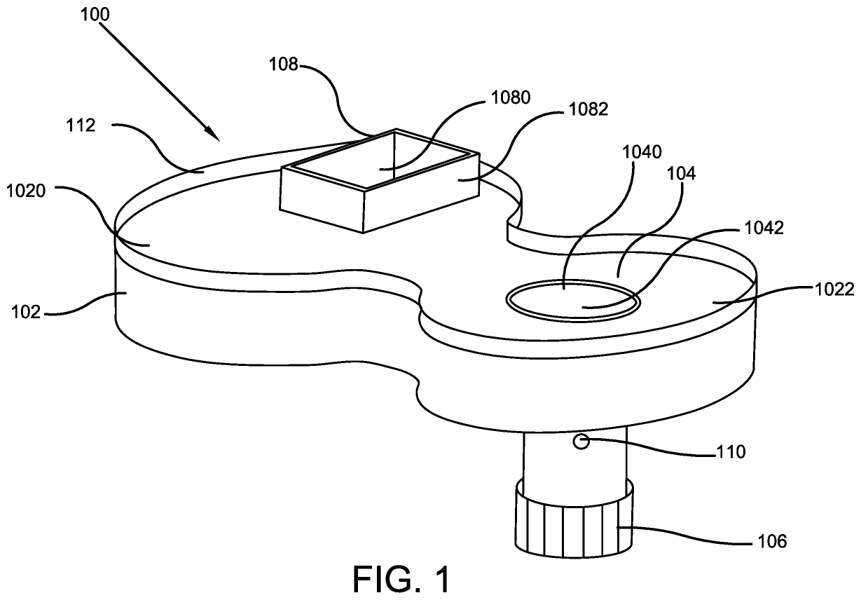

Referring initially to the drawings, FIG. 1 illustrates a perspective view of one potential embodiment of multipurpose cupholder tray insert of the present invention in accordance with the disclosed architecture. The multipurpose cupholder tray insert 100 is designed for placement in a vehicle cup holder to provide a convenient location to place a meal while driving. A vehicle occupant can easily access a beverage and food items by placing the multipurpose cupholder tray insert 100 into an existing cup-holder receptacle in a vehicle seat or child safety seat. The tray insert 100 can also be used with a theater seat, patio chair, foldable chair or any other furniture having a circular section for receiving a circular cross section cup.

The multipurpose tray insert 100 includes a planar tray portion 102 for retaining food or other items. The tray portion 102 includes an anti-slip coating and is surrounded by a rim or lip 112 to prevent food items from easily sliding off of the tray 102. The tray portion 102 includes a plate area having two generally circular planar portions, a larger circular planar portion 1020 and a smaller circular planar portion 1022. The larger circular portion 1020 includes an attached generally rectangular or square pocket 108 for holding snacks, butter, condiments and/or a spread. It is to be appreciated that the pocket 108 can hold food items such as french fries, cookies or other edibles. The pocket 108 includes a plurality of walls 1082 extending vertically for creating an open space 1080 to place the snacks items or condiments therein.

The smaller circular planar portion 1022 includes a beverage sleeve 104 having an opening 1040 configured to receive a beverage container into a sleeve cavity 1042. The beverage sleeve 104 is cylindrical, having walls extending downwards from the smaller circular planar portion 1022. The walls and a floor of the beverage sleeve 104 are configured to support a beverage container placed therein 1042 through the opening 1040. The beverage sleeve 104 is placed on a circular adaptor 106 wherein the circular adaptor 106 is coupled to a keyhole 110. A square key when inserted in the keyhole 110 allows the circular adaptor 106 to expand to snugly fit within a cup holder/receptacle of a vehicle. The tray portion 102 is designed to rotate around the beverage sleeve 104, thereby allowing the planar tray 102 to be rotated and positioned in a desired state as per the desires of the vehicle occupants. The beverage sleeve 104 is rotatable within the circular adaptor 106 allowing the tray portion 102 to rotate and position in a desired orientation.

The height of the beverage sleeve or cylinder 104 is selectable generally from about 3 cm to about 12 cm. The circular adapter 106 can be generally from about 2 cm to about 6 cm in height or depth to ensure a secure and stable fit in a variety of pre-configured cup-holders. It should be noted that keyhole 110 is visible to a user when the multipurpose tray insert 100 is placed within a cup holder allowing the user to use a square key or something similar to expand the circular adapter or cylinder 106 for a snug fit within any size of cup holder.

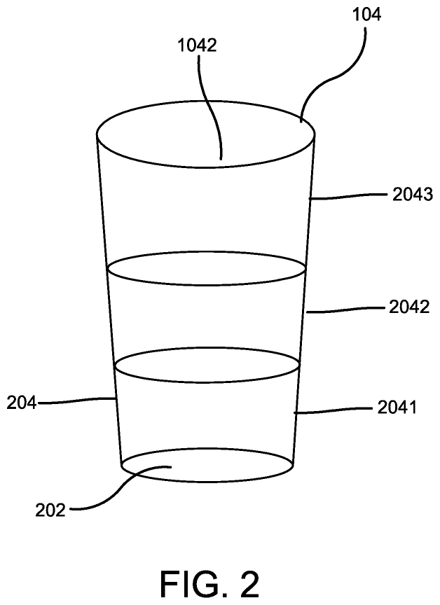

FIG. 2 illustrates an enlarged perspective view showing a beverage sleeve of the multipurpose cupholder tray insert of the present invention in accordance with the disclosed architecture. The beverage sleeve or cylinder 104 includes a floor 202 and side walls 204 integrally formed with and extending upward from the floor 202 to the opening 1040 of the beverage sleeve 104. The beverage sleeve 104 is connected to the circular adaptor at the floor 202, and the beverage sleeve 104 is designed to rotate using the circular adaptor allowing the tray portion to rotate. Further, the beverage sleeve 104 is telescopic and in order to fit in the cup holder of smaller depths, the beverage sleeve can be compressed or retracted. A plurality of telescoping slots can be present along the side walls 204 of the beverage sleeve 104.

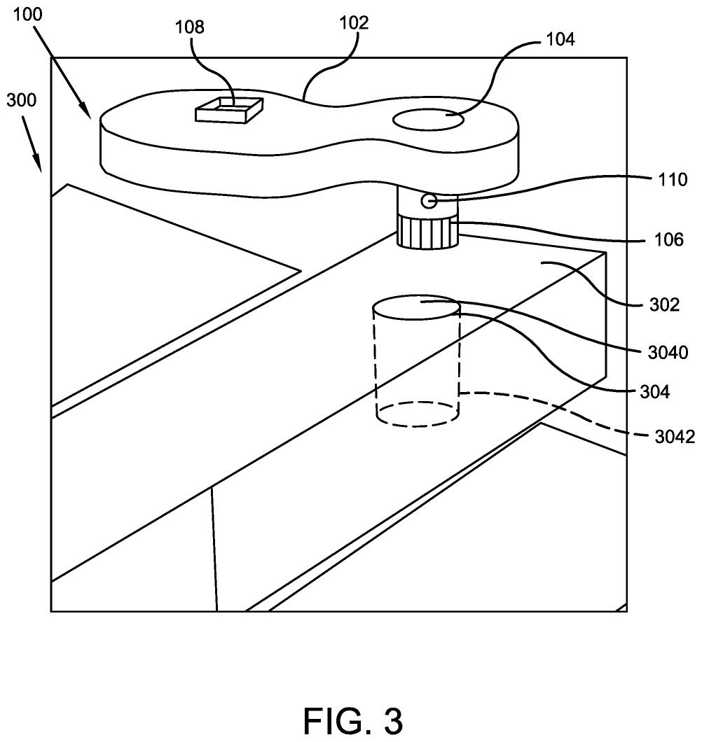

FIG. 3 illustrates a perspective view showing a multipurpose cupholder tray insert of the present invention designed to be inserted in a cup holder of a vehicle in accordance with the disclosed architecture. A cup holder 304 in a portion of a vehicle 300, such as a dashboard or a console 302, is configured to receive a cup holder insert 100 of the present invention. The circular adaptor 106 of the beverage sleeve 104 is inserted into the cavity 3040 of the cup holder/receptacle 304 of the vehicle 300, and a key (not shown) can be inserted into the keyhole 110 on the side wall 204 of the beverage sleeve or cylinder 104. Once the key is inserted into the keyhole 110, the internal expansion mechanism of the circular cylinder 106 can be actuated, thereby causing the adaptor 106 walls to be expanded in order to snugly fit to the interior of walls 3042 of the cup holder 304. This ensures that the tray insert 100 is securely fit to the cup holder 304 and will not move upward when the vehicle traverses bumpy or uneven roads.

The tray portion 102 of the tray insert 100 is configured to rotate as per the preferences of a vehicle occupant, with the beverage sleeve 104 able to be rotated within the circular adaptor 106. The circular adaptor 106 includes a swivel mechanism about which the beverage sleeve 104 rotates. The beverage holder or sleeve 104 is used for storing a beverage container and the pocket 108 is used for storing snacks or spreads without fear of slipping on vehicle seats.

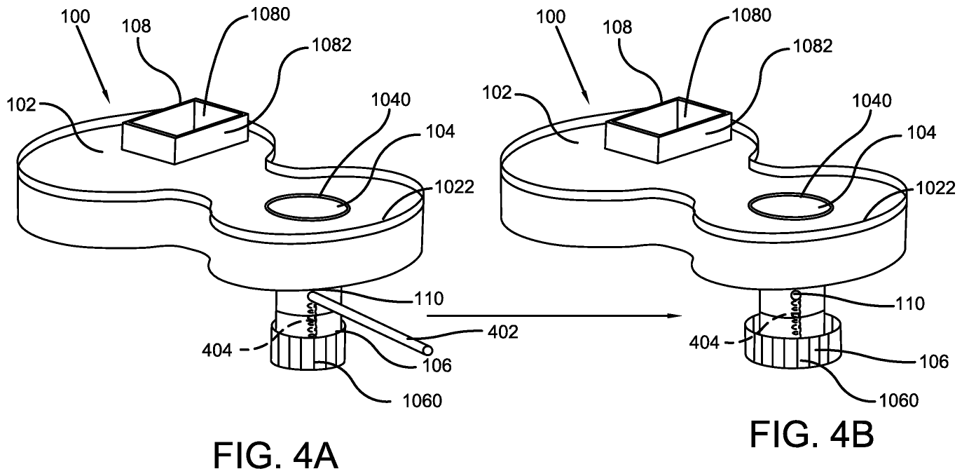

FIG. 4A illustrates a perspective view showing pre-expansion of the circular adaptor of the tray insert of the present invention using a square key in accordance with the disclosed architecture. The circular adaptor 106 is configured to be expandable including a plurality of expandable walls. A square key 402 can be commercially available with the tray insert 100 of the present invention. The square key 402 can be inserted into the hole 110 enabling the circular cylinder 106 to be expanded and snugly fit into any cup holder of a vehicle. As shown, a connection 404, such as a torsional spring, can be configured to connect to the expandable walls 1060 of the circular adaptor 106. When the square key 402 is inserted into the hole 110 and rotated in a first direction, the spring 404 expands allowing the one or more expandable walls 1060 to expand (refer to FIG. 4B) in order to be snugly secured within a cup holder. The swivel mechanism of the circular adaptor 106 enables the rotation of the tray portion 102. The square key 402 can also be rotated in a second direction for retracting the already expanded walls.

In one embodiment, clockwise rotation of the square key 402 in the hole 110 allows the circular adaptor 106 to expand and the counter-clockwise rotation of the square key 402 in the hole 110 allows the circular cylinder 106 to retract. Further, vice-versa key rotation operation for expansion and retraction of the circular adaptor 106 is also possible.

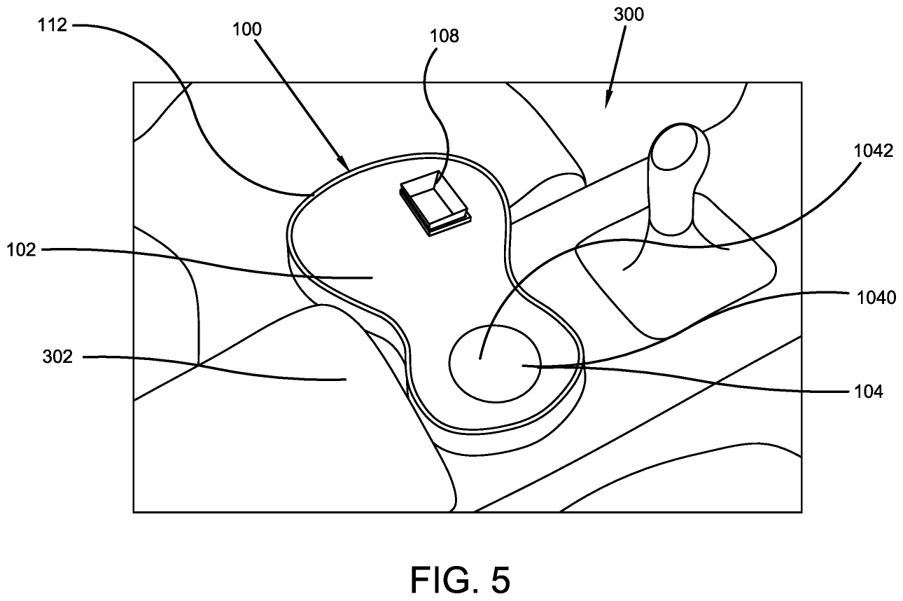

FIG. 5 illustrates a top perspective view showing the multipurpose cupholder tray insert of the present invention positioned in a cup holder in accordance with the disclosed architecture. In the present embodiment, the cup holder is integrated with a center console 302 of a vehicle 300. The tray insert 100 is positioned within the cup holder using the beverage sleeve 104 and the circular adaptor 106 (not shown) as described in the above figs. The beverage sleeve 104 having the opening 1040 is configured to receive a beverage container which fits securely within the cavity 1042 of the beverage sleeve 104. The tray portion 102 and the pocket 108 attached to the tray portion 102 are used for placing food items thereon, thereby enabling a vehicle occupant to position the tray portion 102 in the desired orientation without fear of inadvertent skidding of food items on the tray portion 102. The lip 112, circumscribing the tray portion 102, prevents the food items from falling from the tray 102.

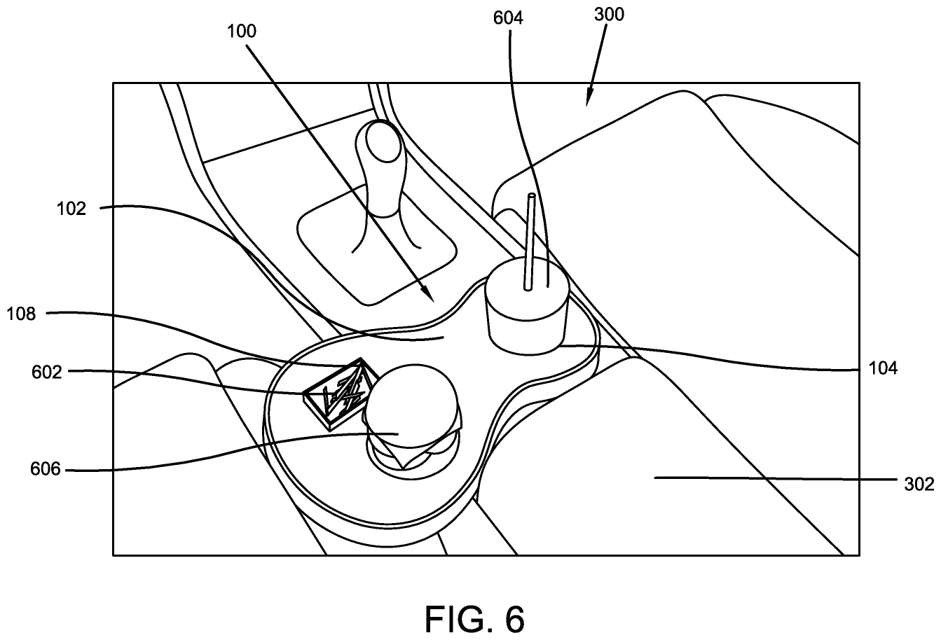

FIG. 6 illustrates a perspective view showing the tray portion rotated towards a driver's seat in accordance with the disclosed architecture. As shown in FIG. 6, the tray insert 100 is placed in the cup holder/receptacle positioned on the console 302 of the vehicle 300. In the present embodiment, the tray portion 102 is positioned towards the driver's seat 600. As described above, the tray portion 102 is easily rotatable using the swivel mechanism. A snack item 602, such as french fries, can be placed in the pocket 108 which is attached to the tray portion 102. A food item 606, such as a burger, can be kept at a convenient position on the tray 102 allowing a user to access the snack item 602 and the food item/burger 606 easily, without any hinderance to the task of driving. Further, a beverage container 604 can be kept in the beverage sleeve 104.

The tray insert 100 and its components can be formed from a durable, food-grade plastic. The insert 100 can also be formed from a material selected from a food-grade thermoplastic, a biodegradable plastic, a molded pulp or a molded foil.

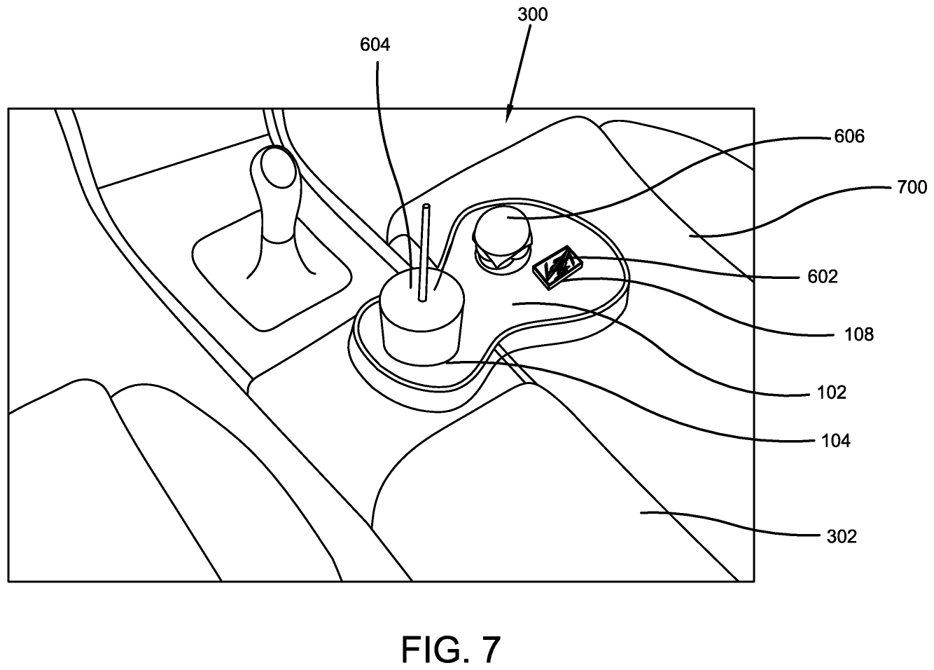

FIG. 7 illustrates a perspective view showing the tray portion rotated towards a passenger's seat in accordance with the disclosed architecture. In the present embodiment, the tray insert 100 is inserted in a cup holder embedded in the console 302 of the vehicle 300 and the tray portion 102 is positioned towards the passenger's seat 700. As described above, the tray portion 102 is easily rotatable using the swivel mechanism. A snack item 602 can be placed in the pocket 108 which is attached to the tray portion 102, and a food item such as a burger 606 can be kept at a convenient position on the tray 102, thereby allowing a passenger to access the snack item 602 and the burger 606 easily without interfering with the task of driving. Further, a beverage container 604 is kept in the beverage sleeve 104.

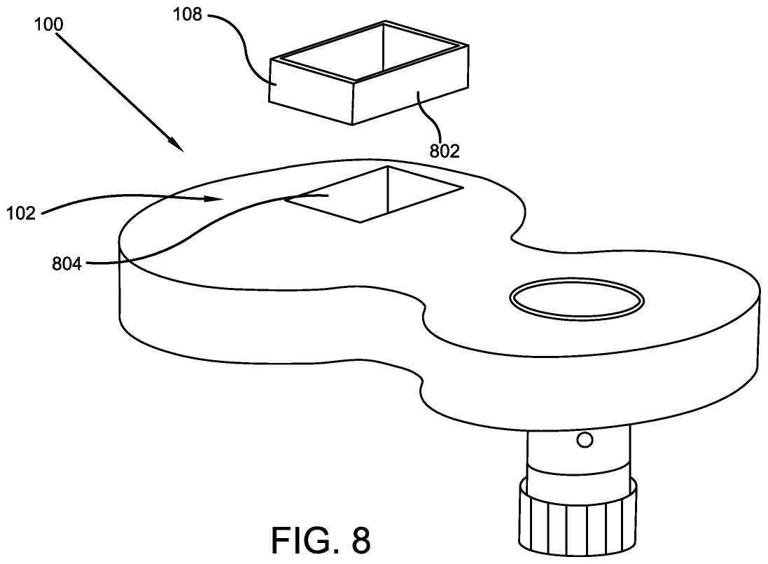

FIG. 8 illustrates a perspective view showing another embodiment of the multipurpose cupholder tray insert of the present invention with a detachable pocket in accordance with the disclosed architecture. In the present embodiment, the pocket 108 is selectively attached to the tray portion 102. The pocket 108 can include a hook fastener 802 to attach to a loop fastener 804 on the tray portion 102, preferably on the larger circular portion. The pocket 108 can be attached or removed as per the preferences of the vehicle occupants.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose cupholder tray insert”, “multipurpose tray insert”, “a tray and beverage insert device”, “tray insert”, “combo meal cup holder”, “insert” and “cup holder rotatable tray insert device”, are interchangeable and refer to the multipurpose cupholder tray insert 100 of the present invention.

Notwithstanding the forgoing, the multipurpose cupholder tray insert 100 of the present invention can be of any suitable size and configuration as is known in the art without affecting the overall concept of the invention, provided that it accomplishes the above-stated objectives. One of ordinary skill in the art will appreciate that the size, configuration, and material of the multipurpose cupholder tray insert 100 as shown in the FIGS. are for illustrative purposes only, and that many other sizes and shapes of the multipurpose cupholder tray insert 100 are well within the scope of the present disclosure. Although the dimensions of the multipurpose cupholder tray insert 100 are important design parameters for user convenience, the multipurpose cupholder tray insert 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-purpose tray and cup holder comprising:
a tray including a plate, a beverage sleeve, and a pocket;
said beverage sleeve including an expandable base for securing in a cup holder;
said expandable base includes an expandable circular adaptor for securing to an interior wall of said cup holder;
said beverage sleeve rotatable within said circular adaptor; and
wherein said tray is rotatable about said cup holder.

2. The multi-purpose tray and cup holder of claim 1, wherein said expandable base includes a key for actuating said expandable circular adaptor.

3. The multi-purpose tray and cup holder of claim 1, wherein said pocket is detachable.

4. The multi-purpose tray and cup holder of claim 1, wherein said cup holder is a vehicle cup holder.

5. The multi-purpose tray and cup holder of claim 1, wherein said cup holder is a chair cup holder.

6. The multi-purpose tray and cup holder of claim 1, wherein said beverage sleeve includes a selectively adjustable height generally from about 3 cm to about 12 cm.

7. The multi-purpose tray and cup holder of claim 6, wherein said beverage sleeve is telescoping for selective adjustment of the height of said tray.

8. The multi-purpose tray and cup holder of claim 6, wherein said circular adaptor includes a depth generally from about 2 cm to about 6 cm.

9. The multi-purpose tray and cup holder of claim 1, wherein said tray includes a raised lip circumscribing a perimeter of said tray.

10. A multi-purpose tray and cup holder comprising:
a tray including a plate and a beverage sleeve extending thereunder;
said beverage sleeve telescoping for selective adjustment of a height of said tray;
said beverage sleeve further comprising an expandable base for securing in a cup holder;
said expandable base includes an expandable circular adaptor for securing to an interior wall of said cup holder;
said beverage sleeve rotatable within said expandable circular adaptor; and
wherein said tray is rotatable about said cup holder.

11. The multi-purpose tray and cup holder of claim 10, wherein said expandable base includes a key for actuating said expandable circular adaptor.

12. The multi-purpose tray and cup holder of claim 10, wherein said tray further comprises a detachable pocket.

13. The multi-purpose tray and cup holder of claim 12, wherein said cup holder is a vehicle cup holder.

14. The multi-purpose tray and cup holder of claim 12, wherein said cup holder is a chair cup holder.

15. The multi-purpose tray and cup holder of claim 14, wherein said beverage sleeve includes a selectively adjustable height generally from about 3 cm to about 12 cm.

16. The multi-purpose tray and cup holder of claim 15, wherein said expandable circular adaptor includes a depth generally from about 2 cm to about 6 cm.

17. The multi-purpose tray and cup holder of claim 10, wherein said tray includes a raised lip circumscribing a perimeter of said tray.

18. A multi-purpose tray and cup holder comprising:
a tray including a plate and a beverage sleeve extending thereunder;
said tray includes a raised lip circumscribing a perimeter of said tray. said beverage sleeve telescoping for selective adjustment of the height of said tray;
said beverage sleeve further including an expandable base for securing in a cup holder;
said expandable base includes an expandable circular adaptor for securing to an interior wall of said cup holder;
said locking base includes a key for actuating said circular adaptor;
said beverage sleeve rotatable within said circular adaptor; and
wherein said tray is rotatable about said cup holder.

19. The holder of claim 18, wherein said beverage sleeve includes a selectively adjustable height generally from about 3 cm to about 12 cm.

20. The holder of claim 19, wherein said circular adaptor includes a depth generally from about 2 cm to about 6 cm.
